(19) United States
(12) Patent Application Publication
(10) Pub. No.: US 2010/0181439 A1
(43) Pub. Date: Jul. 22, 2010

(54) FASTENING ELEMENT FOR FIXING A PIPELINE TO A SUPPORT STRUCTURE

(76) Inventor: Michael Korff, Wroclaw (PL)

Correspondence Address: WOODLING, KROST AND RUST, 9213 CHILLICOTHE ROAD, KIRTLAND, OH, 44094, US

(21) Appl. No.: 12/667,688

(22) PCT Filed: Jul. 7, 2008
(86) PCT No.: PCT/EP08/05528

§ 371 Date: Apr. 7, 2010

(30) Foreign Application Priority Data
Jul. 6, 2007 (DE) 10 2007 031 684.6
May 8, 2008 (DE) 10 2008 022 892.3

(51) Int. Cl. F16L 3/08; F16L 3/02; F16L 55/033; F16L 59/00

(52) U.S. Cl. 248/65; 248/49

(57) ABSTRACT

The invention relates to a fastening element (10) for fixing a pipeline (16) to a support structure, having at least one thermally decoupling support element (12) which surrounds the pipeline (16) at least in regions, at least one fixing element (20) for attaching the support element (12) to the pipeline (16), and connecting means (30) for connecting to the support structure. The invention is characterized in that the contact surface (18a) of the support element (12) extends over an angle of up to and including 180 DEG.

The invention relates to a fastening element for fixing a pipeline to a support structure of the kind stated in the preamble of claim 1.

From the state of the art, fastening elements for pipelines are known which consist out of a commercially available type clip having metallic brackets, wherein a rubber or silicon insert is inserted for isolation purposes in between the metallic bracket and the pipeline to be mounted. Rubber or silicon inserts, respectively, are unsuitable in particular with extremely low and extremely high temperatures in the range of −196 degrees Celsius or +200 degrees Celsius, respectively, since they form thermal bridges, become porous and comprise, thereby, a minor life time.

From the DE 299 10 505 U1, a fixing element of to the above kind is known which serves for fixing a pipeline to a support structure, like a wall, a rail, a frame or the like. The fixing element comprises two thermal isolation elements surrounding the pipeline at least in some areas which isolation elements are formed out of two layers and completely surround the pipeline. The layer arranged closes to the pipeline, consists out of a thermally resistant hard foam having closed cells, for example out of glass or acrylic glass hard foam. The outer layer consists out of a polyurethane foam having closed cells and a surface with a high diffusion resistance factor. Additionally, at least one fixing element in form of a clip consisting out of two semi-circular bended brackets is provided for fixing the isolation elements. The brackets are connected to each other and the clip is tensioned by means of lugs formed at the free ends of the clip. This clip is adapted to be connected to the support structure by means of a bold. The interior surface of the isolation element facing the pipeline is completely coated by synthetic rubber. This rubber has the objective of a sonic noise decoupling between the pipeline, the insulation element and the fixing element. Furthermore, by means of the rubber foil, also a vapour-tide engagement of the insulation elements on the pipeline as well as a protection of the pipeline against damage during the mounting of the fixing element is ensured.

Besides the arrangement of the pipelines by means of fixing elements of the above mentioned type, the pipelines are also thermally isolated in order to keep the thermal exchange with the environment low. The fixing elements on the one side and the thermal isolation on the other side together should ensure a small temperature change of the medium to be transported in the pipeline.

A problem besides the above mentioned thermal isolation of the pipeline, the avoiding of heat bridges through the fixing elements, the sonic noise decoupling of the pipeline with respect to the support structure, and also the protection of the pipeline during the mounting of the fixing element, is the mounting of the pipelines by means of the fixing elements as such. Since such pipelines are mounted by means of fixing elements in most cases on ceilings, walls or the like, i.e. at locations which are not easily accessible, the mounting has to be simple. Also in view of the fact that a pipeline is fixed by means of numerous fixing elements on the supporting structure, a simple mounting is necessary in view of costs.

From the unpublished DE 10 2007 031 684 of the applicant, a fixing element is known which comprises at least two isolation elements which are held by re-tensioning them with respect to each other as well as with the pipeline by means of a clip latch through a fixing element and which surround, thereby, the pipeline essentially completely. However, this embodiment is too complex for some applications.

The invention is based on the object to further develop a fastening element of the type stated in the preamble of claim 1 such that the thermal characteristics of the isolation is maintained and the static functions are fulfilled and the effort for mounting the fastening element is reduced at the same time.

This object is achieved by the characterising features of claim 1 in connection with the features of the preamble.

The invention is based on the finding that a structural unit forms the thermally decoupled support element, that the support element is arranged only below the pipeline and that the pipeline rests on the isolation element. Thereby, a simple construction is ensured.

According to the invention, the support element is, therefore, arranged essentially only in the area of the lower half of the pipeline. Therein, the contact surface of the support element extends over an angle of up to 180° at maximum. Thereby, the support element may simply be applied to the pipeline and fixed thereto. The support element, in particular, forms a structural unit on which the pipeline is resting. Therein, the structural unit forming the support element may be constructed in one piece or in several pieces.

According to an embodiment of the invention, at least one sonic noise decoupling element which is thermally resistant, is arranged at least between the pipeline and the support element and/or between the support elements. By means of the sonic noise decoupling element, oscillations in the pipeline may be decoupled in a simple way, and, in spite of this, a simple construction of the fixing element is ensured.

For the purpose that the fixing element is securely connected to the support element and also that the conditions for a fast mounting are provided, these are connected to each other in a form-locking way.

Such a form-locking connection may be achieved according to an embodiment of the invention thereby that at least one support element surrounds laterally the fixing element and that, for this purpose, the support element comprises two L-shaped, profiled latches arranged symmetrically with respect to each other which latches hold the support element on the fixing element. Thereby, different mounting possibilities are resulting. Preferably, the latches can simply be snapped onto the fixing element whereby the support element is connected to the fixing element in a simple but safe way.

Herein, in particular the latches are formed out of caoutchouc profile or polyurethane foam. In this way, a sufficient elasticity is provided in order to be snap on the fixing element.

In order to ensure a stable mounting, the support element is adapted to the related outer shape of the pipeline which is engaged by the support element with its contact surface on the pipeline.

According to an embodiment of the invention, the isolation element comprises two side portions which are formed symmetrically with respect to the partitioning plane, which is perpendicular to the contact surface. Thereby, the side portions with the latches may be arranged in a simple way from both sides of the fixing element on the same and, subsequently, the two side portions of the support element may be connected to each other.

Preferably the partitioning plane runs centrally through the support element such that all side portions are formed corresponding to each other. Thereby, the production costs can be substantially reduced.

In the area of the isolation, the two side portions of the support element may, therein, be removably connected to each other in between the latches arranged at one end and the sonic noise decoupling element on the other end, without impairing the function of the support element.

According to an embodiment of the invention, the support element extends in a section with respect to the pipeline over an angle up to 90° around the pipeline.

Preferably, both side portions of the support element are reinforced in the connecting area for putting up the stability of the support element. Thereby, a damage of the support element upon mounting or demounting thereof is avoided in a simple manner. In particular, the connecting area may comprise receiving means for connecting means, for example a bushing or the like, for the same purpose.

In order to guarantee a simple arrangement of the connecting element according to the invention, the fixing element comprises a bracket which is formed essentially u-shaped, whereby the support element engages the base and the lower area of both side legs of the u-shaped bracket.

Therein, the connecting means can engage in the area of the ends of the legs of the bracket for connection with the support structure.

For example, the connecting means are screwed together with the support structure.

According to a further embodiment of the invention, the connecting means are formed by a second u-shaped bracket which is connected with its basis to the support structure and is connected with its legs to the legs of the bracket of the fixing element.

The connection of both legs of the fixing element formed as a bracket with the connecting means formed as a bracket, can achieved thereby that a rod extends through both ends of the bracket of the fixing element and that the connecting means engage with the rod. Therein, the rod may also extend through the bracket of the connecting means.

The sonic noise decoupling element may be formed, for example, by a caoutchouc layer in form of a caoutchouc foil, in particular by a synthetic caoutchouc foil. In any case, it is advisable with thermally loaded pipelines that the sonic noise decoupling element is formed thermally resistant. In the mounted state, the caoutchouc foil forming the sonic noise decoupling element, is put under tension by the load of the superposed pipeline whereby also a vapour diffusion barrier is provided for preventing formation of condensate.

The support elements may consist out of different materials, may be formed out of multiple layers for example and may, therein, comprise polyurethane.

The invention also refers to an arrangement comprising a pipeline with an isolation surrounding the pipeline, and a fixing element of the above outlined type. Therein, the isolation of the pipeline is left open in the area of the thermal support element therefore.

The support element with the sonic noise decoupling element can, together with the isolation of the pipeline, completely enclose the pipeline in a vapour-tight manner for avoiding formation of condensate.

Preferably, both legs of the bracket on the side facing away from the first support element extend beyond the isolation of the pipeline. Thereby, further structural possibilities of the fixing element are obtained. For example, the connecting means for connecting the pipeline with the support structure may engage in the area of the ends of the bracket as it has already been explained above.

Further advantages, features and application possibilities of the invention of a fixing element for fixing a pipeline to a support structure are apparent from the following description in connection with the embodiments shown in the drawings.

The invention is described in more detail in the following with reference to the embodiments shown in the drawings. In the specification, in the patent claims, the abstract and the drawings the terms used in the list of reference signs given in the end, and the related reference signs are used. In the drawings:

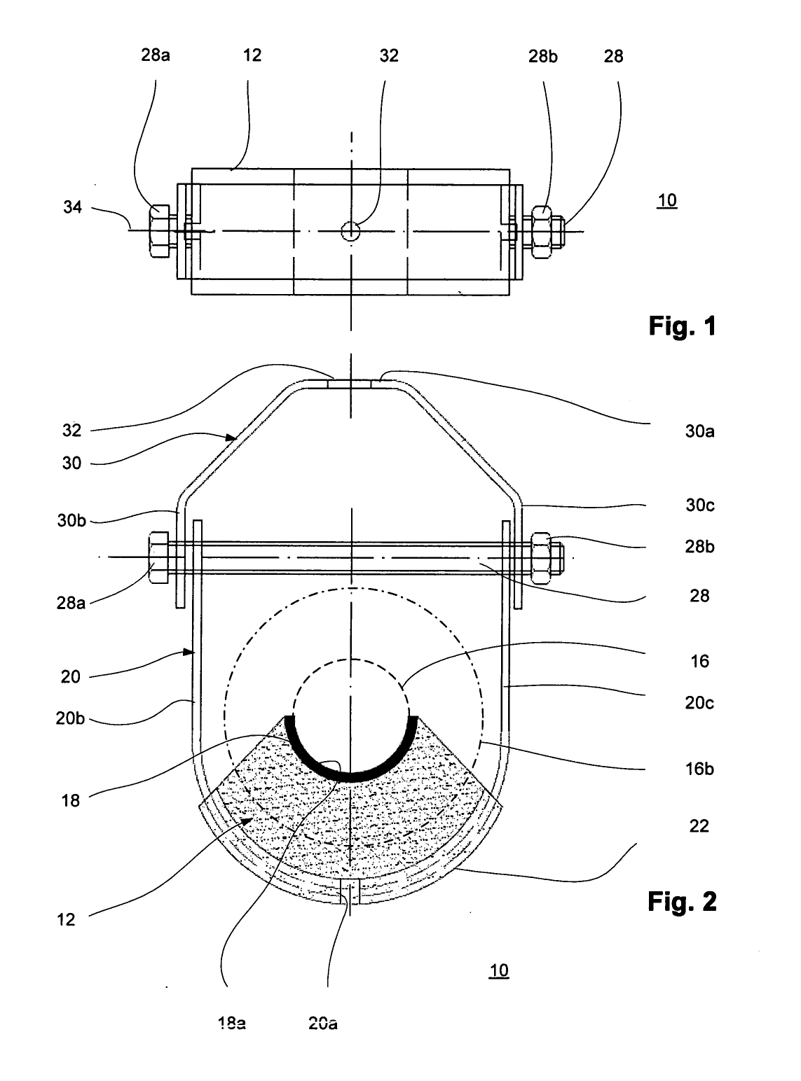

FIG. 1 is a top view of the fixing element for fixing a pipeline on a support structure according to a first embodiment of the invention;

FIG. 2 is a front view of FIG. 1;

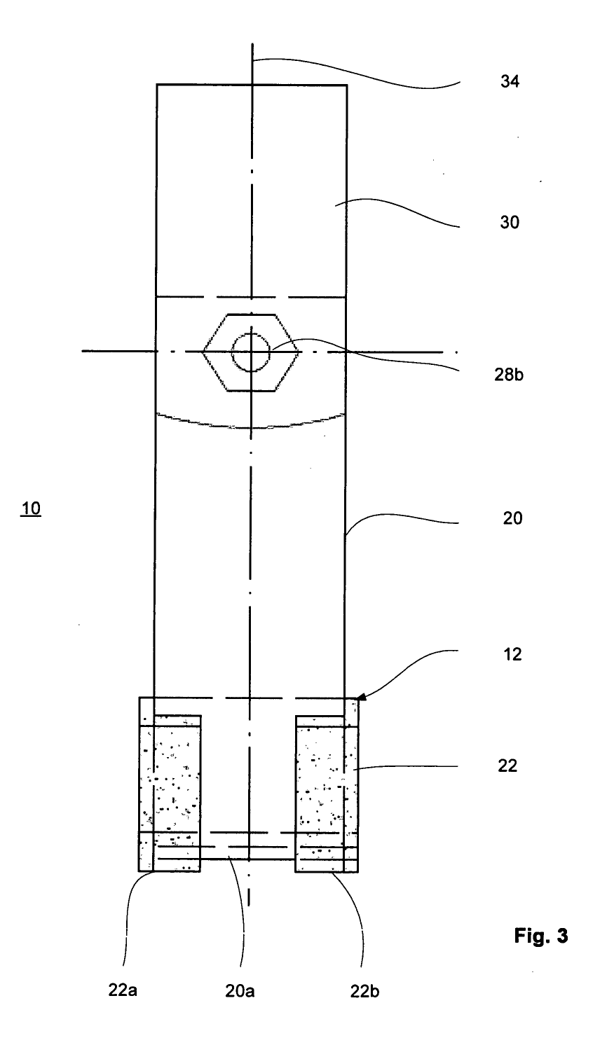

FIG. 3 is a side view of FIG. 1;

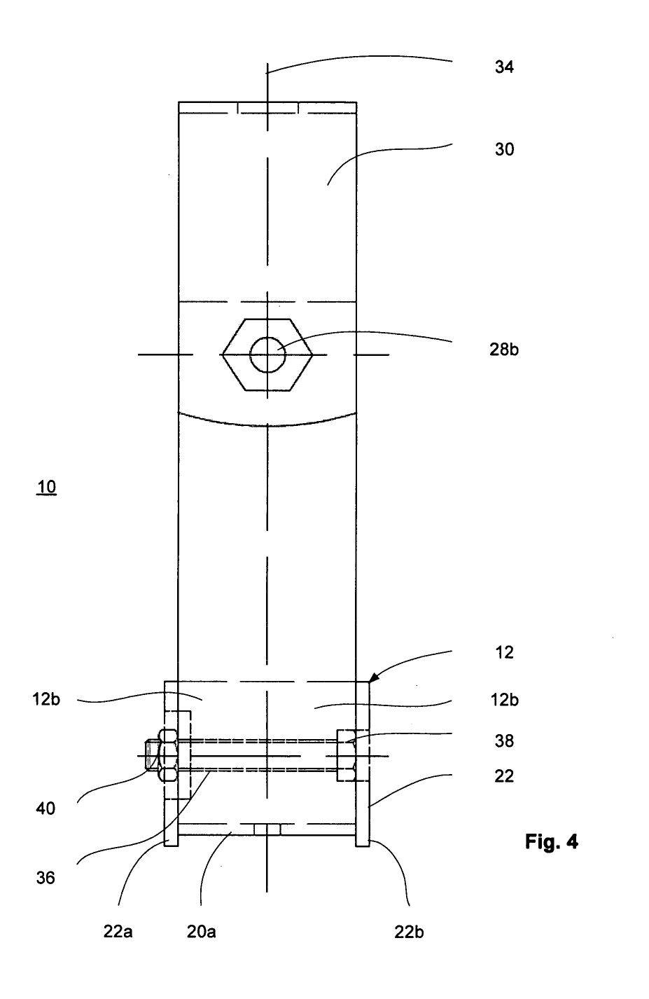

FIG. 4 is a side view on the fixing element for fixing a pipeline on a support structure according to a second embodiment of the invention; and

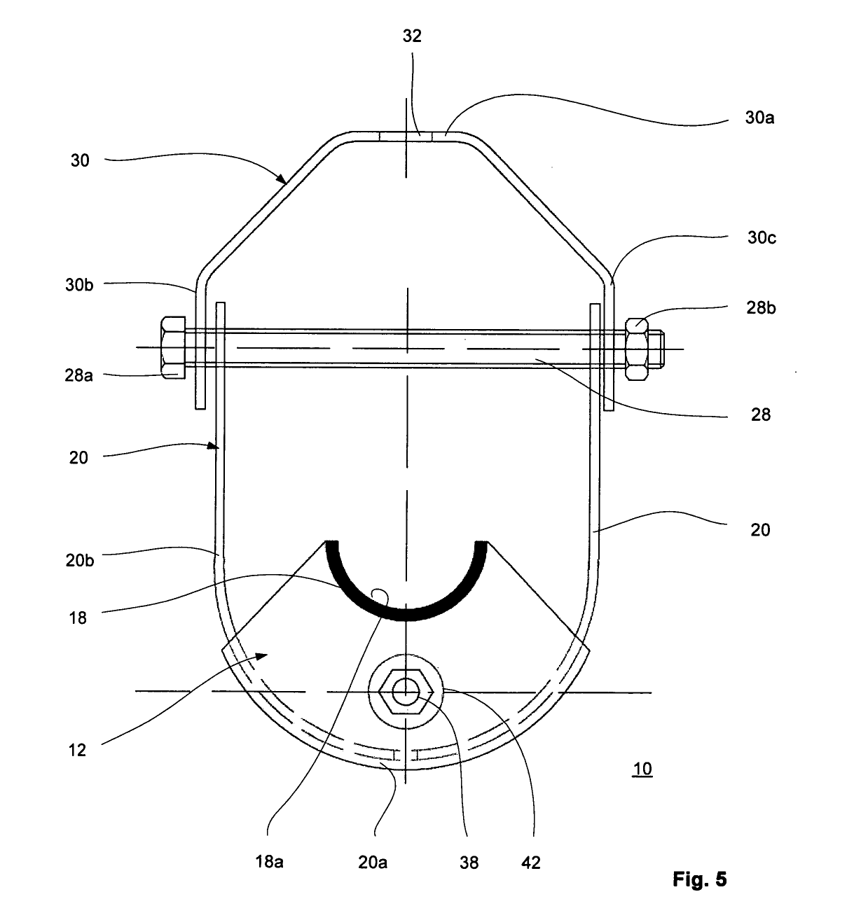

FIG. 5 is a front view of FIG. 4.

In the FIGS. 1 to 3, a first embodiment of the invention is shown. Therein, the fixing element 10 consists out of a lower isolation shell which surrounds the pipeline 16 in part and which extends over an angle of up to 90° around the pipeline 16 and is arranged below the pipeline. Between the isolation shell 12 and the pipeline 16, a sonic noise decoupling element in form of a synthetic caoutchouc foil 18 is inserted. Therein, the isolation shell 12 is essentially formed by a damping element.

A u-shaped bracket 20 surrounds the isolation shell 12. Therein, the isolation shell 12 engages the basis 20a of the bracket 20 from below, but not, however, the vertically extending legs 20b—left side—as well as 20c—right side—. The first isolation shell 12 is formed as a segment of a circle.

The isolation shell 12 comprises latches 22a, 22b surrounding both sides of the bracket 20 which latches are adapted to the outer shape of the bracket 20. The isolation shell 12 is securely fixed on the bracket 20 by means of the latches 22a, 22b.

The free ends of the legs 20b and 20c extend beyond the pipeline 16 with their isolation 16. The isolation 16b of the pipeline 16 is left open in the area of the isolation shell 12 corresponding to the outer shape of the isolation shell 12. The isolation shell 12 and the isolation 16b immediately following the isolation shell 12 in circumferential direction as well as in longitudinal direction of the pipeline 16, and the isolation shell 12 completely surround the pipeline 16 such that no isolation leakage is generated. Furthermore, the isolation 16b also directly engages the isolation shell 12 so that no condensation water can be formed. The isolation 16b together with the isolation shell 12 acts as vapour barrier.

The free ends of the legs 20b and 20c are provided with a recess into which a threaded rod 28 engages which connects the two legs 20b, 20c. The threaded rod 28 is provided, at one side thereof, with a head 28a and is secured by a nut 28b screwed onto the threaded rod 28 at its end distanced away from the head 28a.

Furthermore, the threaded rod 28 extends through a further bracket 30 which is also formed in u-shape. The basis 30a of the bracket 30 is provided with a recess 32 through which the fixing element 10 is screwed together with a support structure. The free ends of the legs 30b and 30c of the bracket 30 are also penetrated by the threaded rod 28. the bracket 20 as well as the bracket 30 comprise a U-shape facing each other, where the bracket 30 surrounds the bracket 20.

For the assembly, first of all, the isolation shell 12 is screwed into the bracket 20 through the latches 22a, 22b onto the bracket 20 such that the isolation shell 12 abuts the basis 20a of the bracket 20. The side of the isolation shell which is spaced away from the basis 20a is provided with the caoutchouc foil 18 acting as sonic noise decoupling element. The bottom area 22 of the support element 12 with the latches 22a, 22b is formed out of rubber, so that the latches 22a and 22b may be snapped from the side over the bracket 20 and such that, thereby, the isolation shell 12 can fixed on the bracket 20.

The bracket 20 with the isolation shell 12 and the caoutchouc foil 18 is now arranged on the pipeline 16 such that the caoutchouc foil 18 abuts the contact surface 18a of the pipeline 16. Subsequently, the threaded rod 28 is inserted through the free ends of the bracket 20 as well as the free ends of the bracket 30 and is fixed by means of the nut 28b.

Either before the assembly of the threaded rod 28 or after the assembly of the threaded rod 28, the basis 30a of the bracket 30 is fixed, for example, screwed together, with a support structure not shown, for example, a wall, a rail, a frame or the like.

In the FIGS. 4 and 5, a further embodiment of the invention is shown. For the same parts the same reference signs are used. Therein, the isolation shell 12 consists out of two side portions 12a and 12b which are symmetrical to a partitioning plane 34 which extends perpendicular to the contact surface 18a of the caoutchouc foil 18 with the pipeline 16. Therein, the partitioning plane 34 extends centrally through the isolation shell 12 and the contact surface 18a.

The two side portions 12a, 12b of the isolation shell 12 are removably fixed to each other in the isolation area between the lower area 22 and the caoutchouc foil 18. Therein, both side portions 12a, 12b are reinforced for putting up the stability of the isolation shell 12 in the area of the connection-reinforcement area. The connecting area surrounds, for this purpose, a bushing 36 for a connection out of a screw 38 and a nut 40 for both side portions 12a, 12b. The latches 22a, 22b are, in this embodiment, integral parts of the side portions 12a, 12b and do not surround the bracket. Furthermore, they are also not formed elastically. Alternatively, both side portions may also be connected with each other by other means, for example, they can be riveted or glued.

In the both embodiments, the isolation shell 12 extends over an angle of up to 90° around the pipeline 16.

The invention is characterised by a simple assembly and the simple fixing of the isolation shell 12 in the bracket 20. The demounting is effected in a correspondingly reversed sequence which demounting is also possible without further means because of the simple construction.

The isolation shell 12 forms, together with the caoutchouc foil 18, a nearly continuously plane front and back side of the fixing element 10. Thereby, the isolation 16b can directly follow without further means for the thermal isolation of the pipeline 16 without heat bridges being created. Only the lower area is projecting somewhat. However, this does not impair the engagement of the isolation 16b, since the isolation 16b of the pipeline 16 does not extend upwards as far as that.

The isolation shell 12 may be formed out of a multiple of layers. Preferably, it comprises polyurethane foam. Instead of a caoutchouc foil 18, also other materials can be used which allow an elastic deformation which are thermally resistant and act as a vapour barrier under the load of the superposed pipeline. Instead of the rubber for the lower area 22 with the latches 22a, 22b, also other elastic materials may be used which ensure an elastic deformation and, thereby, snapping onto the bracket 30.

### LIST OF REFERENCE SIGNS

10 fixing element
12 isolation shell
14 support element
16 pipeline
16b isolation of the pipeline
18 sonic noise decoupling element, caoutchouc foil
18a contact surface
20 bracket
20a basis of the bracket
20b left leg of the bracket
20c right leg of the bracket
22 lower area of the isolation shell
22a latch of the low area—left
22b latch of the lower area—right
24
26
28 threaded rod
28a head of threaded rod
28b nut for the threaded rod
30 further bracket
30a basis of the further bracket
30b leg of the further bracket
30c leg of the further bracket
32 recess
34 partitioning plane
36 bushing
38 screw
40 nut
42 reinforcement area

1-25. (canceled)

26. Fastening element for fixing a pipeline to a support structure, comprising:
at least one thermally decoupling support element which surrounds regions of said pipeline;
said support element includes a contact surface;
at least one fixing element attaching said support element and said contact surface of said support element to said pipeline;
said contact surface of said support element extends over an angle of up to and including 180° at maximum; and,
connecting means for attachment of said support element to said support structure.

27. Fastening element according to claim 26, wherein at least one sonic noise decoupling element is arranged between said pipeline and said support element.

28. Fastening element according to claim 26, wherein said fixing element is connected to said support element in a form-locking way.

29. Fastening element according to claim 28, wherein at least one support element surrounds the fixing element from the side and, said support element comprises two, in section L-shaped, profiled latches arranged symmetrically to each other which hold said support element on said fixing element.

30. Fastening element according to claim 29, wherein said latches are formed out of caoutchouc profile or polyurethane foam.

31. Fastening element according to claim 27, wherein said pipeline includes and outer surface and said contact surface of said support element is adapted to said outer surface of said pipeline.

32. Fastening element according to claim 31, wherein said support element comprises two side portions formed symmetrically to a partitioning plane, which runs perpendicularly through said contact surface of said support element.

33. Fastening element according to claim 32, wherein said partitioning plane extends centrally through said support element.

34. Fastening element according to claim 33, wherein both side portions of said support element are removably connected to each other in an isolation area between latches arranged at the one end, and said sonic noise decoupling element arranged on the other end.

35. Fastening element according to claim 26, wherein said support element extends, in a section of said pipeline, across an angle of up to 90° around said pipeline.

36. Fastening element according to claim 32, wherein both of said side portions of said support element are reinforced for stability of said support element.

37. Fastening element according to claim 35 further comprising a connection portion and said connection portion includes a bushing.

38. Fastening element according to claim 26, wherein said fixing element comprises an essentially u-shaped bracket, said u-shaped bracket includes a base and side legs, and said support element abuts said base and said side legs of said u-shaped bracket.

39. Fastening element according to claim 38, further comprising connection means for attaching said legs of said bracket to said support structure.

40. Fastening element according to claim 39, wherein said legs are fastened with a threaded connector.

41. Fastening element according to claim 39, wherein said connecting means are formed by a u-shaped, second bracket which is connected to said support structure with its basis and is connected with the legs of said bracket of said fixing element by means of its legs.

42. Fastening element according to claim 38, wherein a rod extends through both ends of said bracket of said fixing element, and said connecting means engage a rod.

43. Fastening element according to claim 42, wherein said rod also extends through said bracket of said connecting means.

44. Fastening element according to claim 27, wherein said sonic noise decoupling element is formed by a caoutchouc foil layer.

45. Fastening element according to claim 44, wherein said caoutchouc foil is a synthetic caoutchouc foil.

46. Fastening element according to claim 26, wherein said support element consists of polyurethane.

47. Fastening element according to claim 27, wherein said sonic noise decoupling element is thermally resistive.

48. Arrangement comprising a pipeline having an isolation material partially surrounding said pipeline, and a fastening element, wherein said isolation of the pipeline is incomplete.

49. Arrangement according to claim 48, wherein said support element with said sonic noise decoupling element together with said partial isolation of said pipeline surrounds said pipeline completely in a vapour-tight manner for avoiding formation of condensate.

50. Arrangement according to claim 48, wherein said fastener includes a bracket and said bracket includes legs extending beyond said isolation of said pipeline and being spaced away from said support element.
